(19) United States
(12) Patent Application Publication
(10) Pub. No.: US 2023/0306479 A1
(43) Pub. Date: Sep. 28, 2023

(54) SYSTEMS AND METHODS OF UTILITY DATA TRIANGULATION TO VERIFY DATA ACCURACY

(71) Applicant: Arcadia Power, Inc., Washington, DC (US)

(72) Inventors: John Tucker, Woodstock, VT (US); Jason Riley, San Francisco, CA (US); San Prabhu, San Ramon, CA (US); Ruben Garcia, Moraga, CA (US)

(21) Appl. No.: 17/701,776

(22) Filed: Mar. 23, 2022

(51) Int. Cl. G06Q 30/04; G06Q 50/06

(52) U.S. Cl. CPC G06Q 30/04; G06Q 50/06

(57) ABSTRACT

Systems and methods may be provided to receive, at a server, a utility bill and interval data for a user of an energy utility, and store the received utility bill and interval data in a database system communicatively coupled to the server. The received utility bill may include a date range for the bill and a tariff. The received interval data may include data used by the energy utility for determining costs. A calculation engine of the server may determine a model bill based on the received utility bill and the interval data. The server may determine an accuracy of a utility bill issued by the energy utility to by determining whether the model bill matches the utility bill. The server may verify the utility bill, the interval data, and the tariff as accurate when the model bill matches the utility bill based on the accuracy determination.

### BACKGROUND

Presently, energy utilities provide electricity or other forms of energy to customers. Information regarding energy usage by customers is recorded using an interval meter, which may be read by representatives of the energy utility or transmitted to the energy utility. The recorded energy usage may be used to generate an energy bill for a customer. Errors in billing can result from incorrect energy rates and/or tariffs being applied by the energy utility, and/or by inaccurate interval data.

### BRIEF SUMMARY

According to an implementation of the disclosed subject matter, a method may be provided to receive, at a server, a utility bill and interval data for a user of an energy utility, and store the received utility bill and interval data in a database system communicatively coupled to the server. The received utility bill may include a date range for the bill and a tariff. The received interval data may include data used by the energy utility for determining costs. A calculation engine of the server may determine a model bill based on the received utility bill and the interval data. The server may determine an accuracy of a utility bill issued by the energy utility to by determining whether the model bill matches the utility bill. The server may verify the utility bill, the interval data, and the tariff as accurate when the model bill matches the utility bill based on the accuracy determination.

Additional features, advantages, and implementations of the disclosed subject matter may be set forth or apparent from consideration of the following detailed description, drawings, and claims. Moreover, it is to be understood that both the foregoing summary and the following detailed description are illustrative and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description serve to explain the principles of implementations of the disclosed subject matter. No attempt is made to show structural details in more detail than may be necessary for a fundamental understanding of the disclosed subject matter and various ways in which it may be practiced.

FIG. 1 shows an example method of determining data accuracy of an energy utility, including energy consumption and billing, according to an implementation of the disclosed subject matter.

FIGS. 2-4G show optional additional operations of the example method of FIG. 1 according to implementations of the disclosed subject matter.

FIG. 5 shows a network arrangement of energy generating systems, servers, databases, and customer devices according to an implementation of the disclosed subject matter.

FIG. 6 shows a device that may interface with the network arrangement shown in FIG. 5 according to an implementation of the disclosed subject matter.

### DETAILED DESCRIPTION

Implementations of the disclosed subject matter provide systems and methods for determining the accuracy of data for an energy utility. The data may be used to generate utility bills by the energy utility, and may be used to verify the accuracy of utility bills for a user. Intervals recorded by an interval meter and/or smart meter, and/or tariff records stored in a database system may be used to verify the accuracy of the data and/or the utility bills. By triangulating datasets of the interval data, tariff data, and utility bill data, implementations of the disclosed subject matter may verify the accuracy of each dataset.

To verify accuracy, the interval data and a tariff model may be used to determine a model bill to “mirror” the utility bill. When the model bill matches the utility bill issued by the energy utility, the three datasets (i.e., the interval data, tariff data, and utility bill data) may be verified as being accurate. When the model bill does not match the utility bill, a source of the inaccuracy may be determined. In some implementations, an accuracy score may be generated.

Implementations of the disclosed subject matter verify the accuracy of data, including interval meter data, tariff data, and/or utility bills. The interval data may be provided to a calculation engine of the server, and the calculation engine may “mirror” and/or replicate the process by the energy utility to generate a utility bill, and may determine the model bill. A discrepancy between the model bill and the energy bill may indicate that the interval data used is different (i.e., the interval data retrieved from the utility is incorrect), the tariff model is incorrect and/or out of date, the utility billing system of the energy utility made an error in calculating the utility bill of the user, or the like.

Implementations of the disclosed subject matter may provide data via an application program interface (API) to users of different utilities so that they may determine the accuracy of the data used for utility bills.

Continuous triangulation of datasets of the interval data, tariff data, and utility bill data over time may lead to increased accuracy in data collection by the energy utility, and/or accuracy in billing of customers of the energy utility based on validated usage, energy rates, and/or tariffs. Verified accuracy of the data may help users determine the actual amount of energy used, along with the costs for using such energy at particular times. Users may adjust the time of energy consumption, amount of energy consumption, and the like when they have accurate data regarding the interval data, tariff data, and utility bill data.

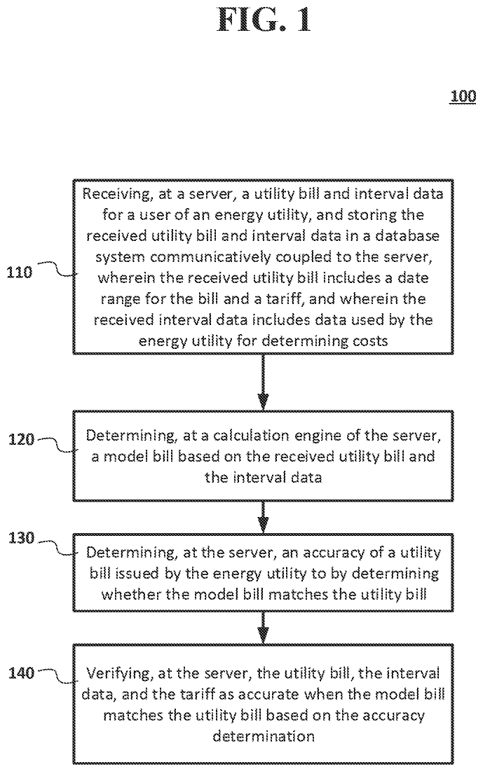

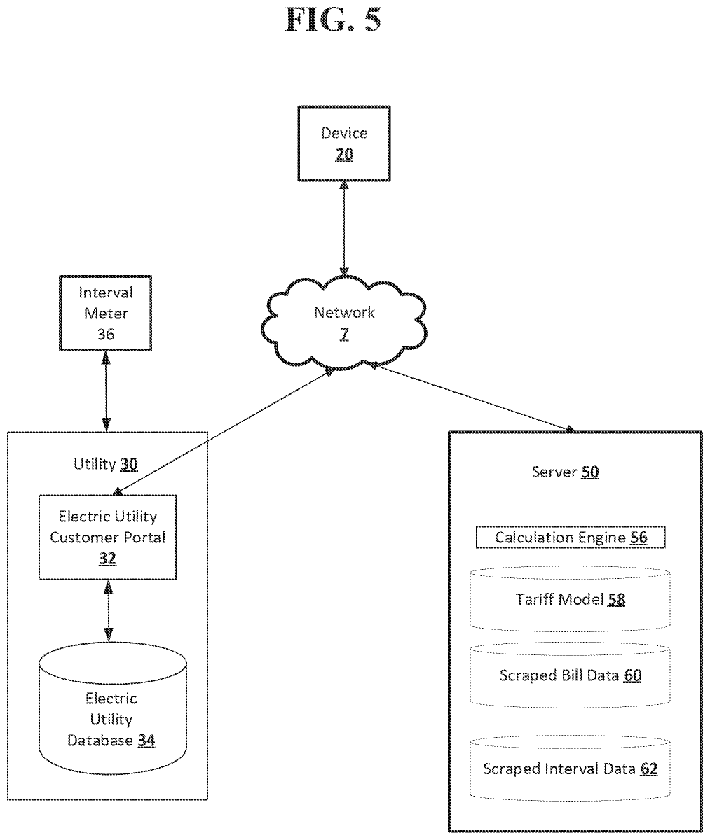

FIG. 1 shows an example method 100 of determining data accuracy of an energy utility, including energy consumption and billing, according to an implementation of the disclosed subject matter. At operation 110, a server may receive a utility bill and interval data for a user of an energy utility, and store the received utility bill and interval data in a database communicatively coupled to the server. The server may server 50, shown in FIG. 5 and described below. The utility bill may be received by the server 50 from the electric utility customer portal 32 of the utility 30 via the communications network 7, as shown in FIG. 5. In some implementations, the utility bill may be received from device 20. The energy utility may be utility 30 shown in FIG. 5. The received utility bill may be stored in scraped bill data 60, and the interval data may be stored in scraped interval data 62 shown in FIG. 5.

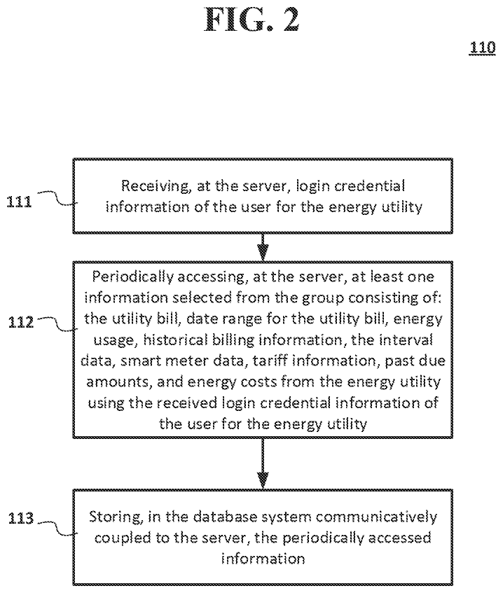

In some implementations, the interval data may be received from interval meter 36, which may monitor energy usage (e.g., usage of electricity) provided by utility 30 to the customer (i.e., user). The interval meter 361 may be a smart meter or other suitable interval meter. The interval data may be a fine-grained record of energy consumption, with readings made at regular intervals throughout the day, which may be performed every day. The interval data may be collected by the interval meter 36. At the end of every interval period, the interval meter 36 may record how much energy was used in an interval period. That is, interval data may be transmitted to the utility 30 via communications network 7, and the server 50 may retrieve the interval data via the communications network 7 using login credential information of the user, as described below in connection with FIG. 2.

The utility bill received in operation 110 may include a date range for the bill and a tariff. The received interval data may include data used by the energy utility for determining costs for the utility bill. The tariff may be based on the user's location, whether the user is a commercial customer or a residential customer, or the like.

In some implementations, the receiving the utility bill and the interval data of operation 110 may optionally include the operations shown in FIG. 2. At operation 111, the server may receive login credential information of the user for the energy utility. For example, the server of the server 50 may use the login credential information to access the electric utility customer portal 32 and/or the electric utility database 34. At operation 112, the server may periodically access the utility bill, date range for the utility bill, energy usage, historical billing information, the interval data, smart meter data, tariff information, past due amounts, and/or energy costs from the energy utility (e.g., from the electric utility customer portal 32 and/or the electric utility database 34) using the received login credential information of the user for the energy utility. At operation 113, the information that is retrieved via the periodic access at operation 112 may be stored in the database system (e.g., tariff model 58, scraped bill data 60, and/or scraped interval data 62 shown in FIG. 5) that is communicatively coupled to the server.

That is, in implementations of the disclosed subject matter, a user may share their utility login credentials with the electric utility customer portal 32 of utility 30 shown in FIG. 5 with the server 50. The server 50 may access materials that the utility 30 may publish via the electric utility customer portal 32, which may be retrieved and stored in database system (e.g., tariff model 58, scraped bill data 60, and/or scraped interval data 62). For example, the server 50 may retrieve a summary of charges to the user by the energy utility 30, which may include one or more documents and/or data with the user's most recent bill and historical billing information.

The server 50 may use the login credential information of the user to access the user's account with the utility 30 via the electric utility customer portal 32. The user's account data may be downloaded to the server of server 50, and may be stored in the database system (e.g., in tariff model 58, scraped bill data 60, and/or scraped interval data 62). At least portions of the retrieved data may be normalized and stored (e.g., in tariff model 58, scraped bill data 60, and/or scraped interval data 62) for use in one or more applications.

For example, a user's bill may be retrieved by the server of the server 50, along with interval data, the tariff assigned to the user, the utility costs for the user, a past due amount, and the like. When extracting and/or retrieving interval data, the server of the server 50 may normalize the data for the Universal Time Zone before storing the data in the database system (e.g., tariff model 58, scraped bill data 60, and/or scraped interval data 62) so that the data is in a consistent format across utilities (e.g., utility 30 and other energy utilities). Data retrieval may be performed on a periodic basis to capture new utility bills and interval data as they become available at the electric utility customer portal 32 of the utility 30.

At operation 120 of FIG. 1, a calculation engine of the server may determine a model bill based on the received utility bill and the interval data from operation 110. The calculation engine may be calculation engine 56 shown in FIG. 5, which may include hardware and/or software which may determine the model bill. Implementations of the disclosed subject matter may determine the model bill to determine the accuracy of the data that may be used by the energy utility to generate the utility bill.

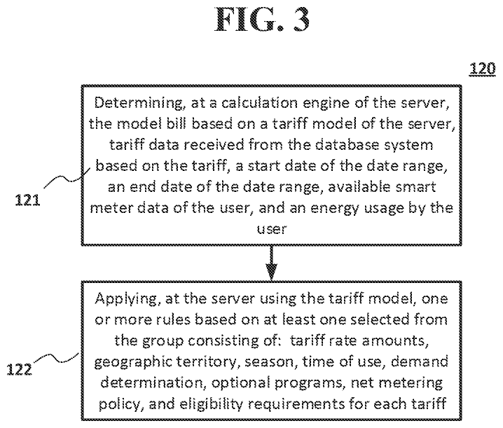

In some implementations, operation 120 of FIG. 1 may optionally include the operations shown in FIG. 3. At operation 121 of FIG. 3, the calculation engine of the server (e.g., calculation engine 56 shown in FIG. 5) may determine the model bill based on a tariff model (e.g., tariff model 58 shown in FIG. 5) of the server, tariff data received from the database (e.g., which may be stored in the tariff model 58 and/or in scraped bill data 60) based on the tariff, a start date of the date range, an end date of the date range, available smart meter data of the user, and/or an energy usage. The calculation engine 56 may determine the model bill using the same rules as used by the energy utility in generating the utility bill. The calculation engine 56 may use a tariff, a start date of the date range, an end date of the date ran, energy usage, and the like to determine the model bill.

In some implementations, operation 122 as shown in FIG. 3 may be optionally performed. Using the tariff model, the server may apply one or more rules based on tariff rate amounts, geographic territory, season, time of use, demand determination, optional programs, net metering policy, and/or eligibility requirements for each tariff. The tariff model may be tariff model 58 shown in FIG. 5, which may include hardware and/or software for modelling a tariff applied by the utility 30 for a utility bill for a user.

In some implementations, the calculation engine (e.g., calculation engine 56) of the server may provide an application program interface (API) to calculate costs across a plurality of different energy utilities. Other companies, servers, and/or devices may access utility data of their users that may be stored in the database system (e.g., in tariff model 58, scraped bill data 60, and/or in scraped interval data 62) using the API.

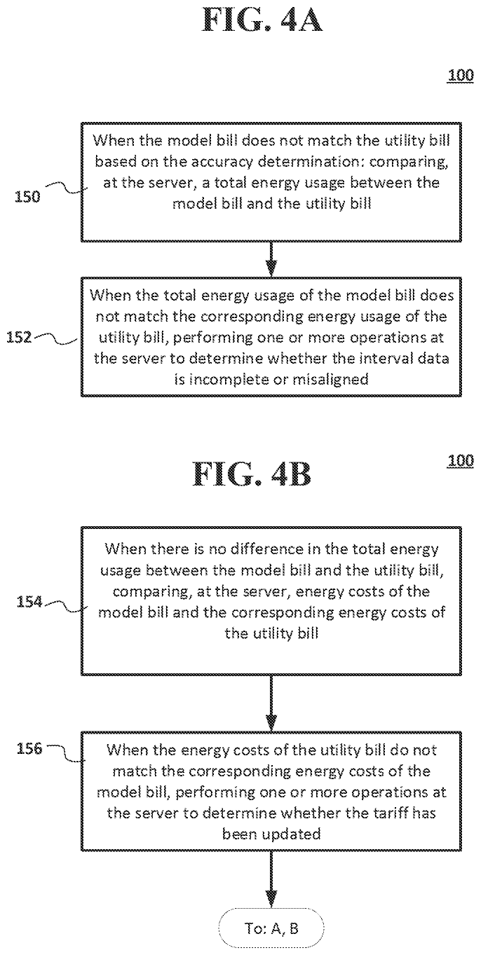

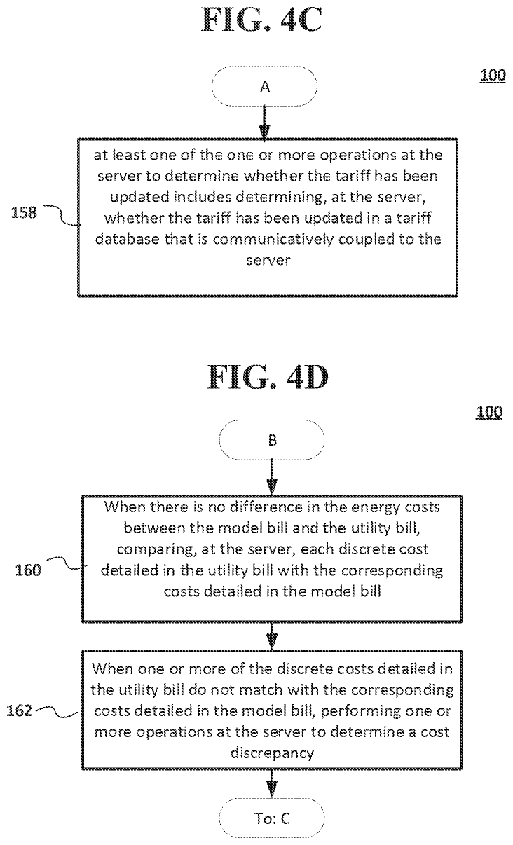

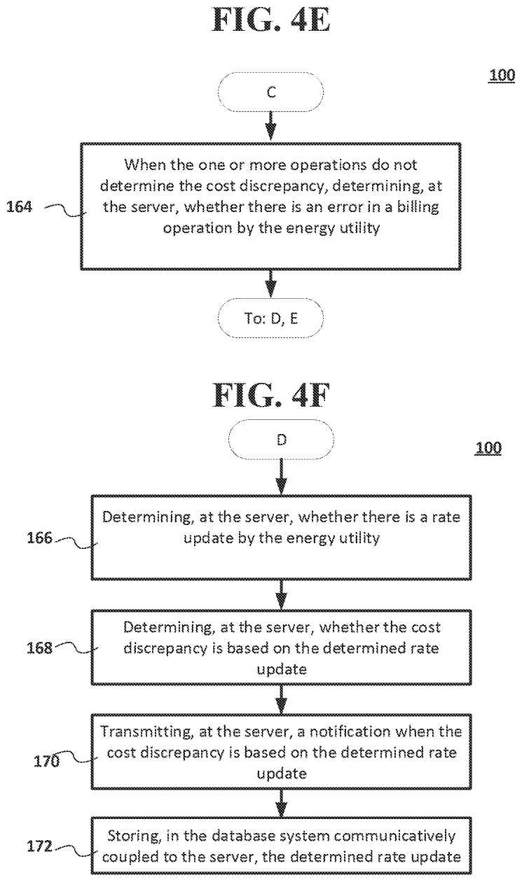

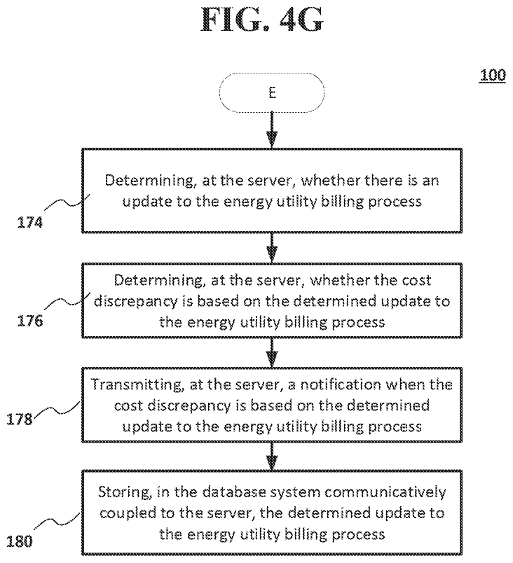

At operation 130, the server may determine an accuracy of a utility bill issued by the energy utility to by determining whether the model bill matches the utility bill. At operation 140, the server may validate the utility bill, the interval data, and the tariff as accurate when the model bill matches the utility bill based on the accuracy determination. Operations in the determination of the accuracy may be shown in FIGS. 4A-4G and discussed below.

FIGS. 4A-4G show optional operations of method 100 according to implementations of the disclosed subject matter. The server (e.g., the server 50) may transmit, via a communications interface, a notification when the model bill does not match the utility bill based on the accuracy determination at operation 130 shown in FIG. 1. As shown in FIG. 4A, when the model bill does not match the utility bill based on the accuracy determination, the server may compare a total energy usage between the model bill and the utility bill at operation 150. When the total energy usage of the model bill does not match the corresponding energy usage of the utility bill, the server may perform one or more operations to determine whether the interval data is incomplete or misaligned at operation 152.

For example, when there is a discrepancy between the model bill and the utility bill for usage, the server may determine that there is a discrepancy with the interval data and/or scrapers captured the wrong data. For example, the server may determine whether the interval length changes over time, or whether it stays the same. In another example, the server may determine whether the intervals are accurately recorded, and have the same time zone (e.g., Universal Time Zone). In yet another example, the server may determine whether there is a reading (i.e., interval data) for each interval period. In another example, the server may determine whether the interval data is contiguous, or whether there are zero (0) readings (i.e., no interval data) followed by an interval with increased data and/or energy usage. The server may confirm the accuracy of the intervals to determine the accuracy of the utility bill.

As shown in FIG. 4B, when there is no difference in the total energy usage between the model bill and the utility bill, the server may compare energy costs of the model bill and the corresponding energy costs of the utility bill at operation 154. When the energy costs of the utility bill do not match the corresponding energy costs of the model bill, the server may perform one or more operations to determine whether the tariff has been updated at operation 156. That is, when the energy costs of the utility bill does not match the corresponding energy costs of the model bill, the server may determine whether the mismatch is because the tariff has been updated by the utility (e.g., update the tariff rates in the electric utility database 34 of the utility 30) and the new rates have not yet been added to a tariff database that may be part of the database system (e.g., in tariff model 58, scraped bill data 60, and/or in scraped interval data 62). In some implementations, the results of the comparison may be stored and timestamped in the database system (e.g., in tariff model 58, scraped bill data 60, and/or in scraped interval data 62). The results of the comparison may be used to determine the accuracy of the tariff used in determining the model bill. The timestamps may allow the server of the server 50 to communicate with devices of users that made API calls that were returned incorrectly during the time the tariff database of database system (e.g., tariff model 58,) was updated with the new tariff rates.

In some implementations, operation 158 as shown in FIG. 4C may be performed after operation 156 of FIG. 4B. In operation 158, at least one of the one or more operations at the server to determine whether the tariff has been updated may include determining, at the server, whether the tariff has been updated in a tariff database that is communicatively coupled to the server.

In some implementations, the operations as shown in FIG. 4D may be performed after operation 156 of FIG. 4B. When there is no difference in the energy costs between the model bill and the utility bill, the server may compare each discrete cost detailed in the utility bill with the corresponding costs detailed in the model bill at operation 160. When one or more of the discrete costs detailed in the utility bill do not match with the corresponding costs detailed in the model bill, the server may perform one or more operations to determine a cost discrepancy at operation 162.

In some implementations, the operations shown in FIG. 4E may be performed after operation 162 shown in FIG. 4D. When the one or more operations do not determine the cost discrepancy, the server may determine whether there is an error in a billing operation by the energy utility at operation 164.

In some implementations, the determining of whether there is an error in a billing operation by the energy utility at operation 164 of FIG. 4E may include the operations as shown in FIG. 4F. At operation 166, the server may determine whether there is a rate update by the energy utility. At operation 168, the server may determine whether the cost discrepancy is based on the determined rate update. At operation 170, the server may transmit a notification when the cost discrepancy is based on the determined rate update. At operation 172, the determined rate update may be stored in the database system communicatively coupled to the server.

In some implementations, the determining of whether there is an error in a billing operation by the energy utility at operation 164 of FIG. 4E may include the operations as shown in FIG. 4G. At operation 174, the server may determine whether there is an update to the energy utility billing process. At operation 176, the server may determine whether the cost discrepancy is based on the determined update to the energy utility billing process. At operation 178, the server may transmit a notification when the cost discrepancy is based on the determined update to the energy utility billing process. At operation 180, the determined update to the energy utility billing process may be stored in the database communicatively coupled to the server. In some implementations, if the discrepancy is not identified in the operations shown in FIGS. 4A-4G, the discrepancy may be an error in the billing system of the utility, and the server 50 may perform one or more operation to aggregate data of the error for resolution with the utility 30 and/or a governing utility commission.

FIG. 5 shows a network arrangement of energy generating systems, servers, databases, and customer devices according to an implementation of the disclosed subject matter. A utility 30 (i.e., an electric utility) may generate electricity to be provided to one or more customers via a power grid. The utility 30 may include a server that provides an electric utility customer portal 32, which may allow customers to access account information with the utility 30. Account information may include, for example, utility bills, payment information, amount of energy used, address and contact information, and the like. The server of the utility 30 may be one or more hardware servers and or a cloud server. The server of the utility 30 that provides the electric utility customer portal 32 may be communicatively coupled to an electric utility database 34, which may store, among other things, historic utility bill statements for one or more customers. The utility 30 may be communicatively coupled to the server 13 via communications network 7.

The server 50 may be one or more hardware servers, a cloud server, or the like which may include and/or be communicatively coupled to calculation engine 56, tariff model 58, scraped bill data 60, and/or scraped interval data 62.

Calculation engine 56 may be hardware and/or software which may determine the model bill and/or determine the accuracy of the utility bill as discussed above in connection with FIGS. 1-4G. Tariff model 58 may be hardware, software, and/or a database that may be used by the calculation engine 56 to determine the model bill based on tariff data, a start date of the date range, an end date of the date range, available smart meter data of the user, and/or an energy usage. The tariff model 58 may be hardware, software, and/or a database that may include a tariff (i.e., a tariff value), and rules for application of the tariff.

Scraped bill data 60 may be hardware, software, and/or a database that may include one or more hardware storage devices that may store tariffs, start dates and end dates of date ranges, billing information, energy usage data, other data, and the like. Scraped interval data 62 may be hardware, software, and/or a database that may include one or more hardware storage devices that may store interval data that may be scraped from a utility bill, the interval meter 36, or the like.

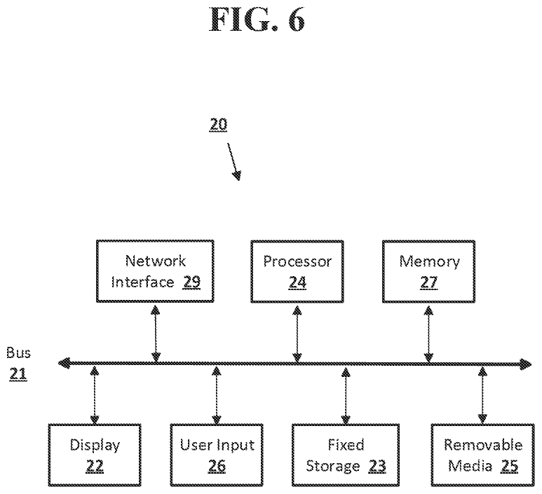

The utility 30, the server 50, and a customer device 20 (described below in connection with FIG. 6) may be communicatively connected via communications network 7. The network 7 may be a local network, wide-area network, the Internet, or any other suitable communication network or networks, and may be implemented on any suitable platform including wired and/or wireless networks.

Embodiments of the presently disclosed subject matter may be implemented in and used with a variety of component and network architectures. FIG. 6 is an example device 20 that may a desktop or laptop computer, or a mobile computing device such as a smart phone, tablet, or the like. In some implementations, the device 20 may be used to manage an account with the utility 30, receive notifications and/or data verification information from the server 50, or the like. The device 20 may include a bus 21 which interconnects major components of the device 20, such as a central processor 24, a memory 27 such as Random Access Memory (RAM), Read Only Memory (ROM), flash RAM, or the like, a user display 22 such as a display screen, a user input interface 26, which may include one or more controllers and associated user input devices such as a keyboard, mouse, touch screen, and the like, a fixed storage 23 such as a hard drive, flash storage, and the like, a removable media component 25 operative to control and receive an optical disk, flash drive, and the like, and a network interface 29 operable to communicate with one or more remote devices via a suitable network connection.

The bus 21 allows data communication between the central processor 24 and one or more memory components, which may include RAM, ROM, and other memory, as previously noted. Typically, RAM is the main memory into which an operating system and application programs are loaded. A ROM or flash memory component can contain, among other code, the Basic Input-Output system (BIOS) which controls basic hardware operation such as the interaction with peripheral components. Applications resident with the device 20 are generally stored on and accessed via a computer readable medium, such as a hard disk drive (e.g., fixed storage 23), an optical drive, floppy disk, or other storage medium.

The fixed storage 23 may be integral with the device 20 or may be separate and accessed through other interfaces. The network interface 29 may provide a direct connection to a remote server via a wired or wireless connection. The network interface 29 may provide such connection using any suitable technique and protocol as will be readily understood by one of skill in the art, including digital cellular telephone, WiFi, Bluetooth®, near-field, and the like. For example, the network interface 29 may allow the computer to communicate with other computers via one or more local, wide-area, or other communication networks, as described in further detail below.

Many other devices or components (not shown) may be connected in a similar manner (e.g., sensors, energy use monitors, and the like). Conversely, all of the components shown in FIG. 15 need not be present to practice the present disclosure. The components can be interconnected in different ways from that shown. The operation of the device 20 such as that shown in FIG. 15 is readily known in the art and is not discussed in detail in this application. Code to implement the present disclosure can be stored in computer-readable storage media such as one or more of the memory 27, fixed storage 23, removable media 25, or on a remote storage location.

More generally, various implementations of the presently disclosed subject matter may include or be embodied in the form of computer-implemented processes and apparatuses for practicing those processes. Implementations also may be embodied in the form of a computer program product having computer program code containing instructions embodied in non-transitory and/or tangible media, such as floppy diskettes, CD-ROMs, hard drives, USB (universal serial bus) drives, or any other machine readable storage medium, such that when the computer program code is loaded into and executed by a computer, the computer becomes an apparatus for practicing implementations of the disclosed subject matter. Implementations also may be embodied in the form of computer program code, for example, whether stored in a storage medium, loaded into and/or executed by a computer, or transmitted over some transmission medium, such as over electrical wiring or cabling, through fiber optics, or via electromagnetic radiation, such that when the computer program code is loaded into and executed by a computer, the computer becomes an apparatus for practicing implementations of the disclosed subject matter. When implemented on a general-purpose microprocessor, the computer program code segments configure the microprocessor to create specific logic circuits.

In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Implementations may be implemented using hardware that may include a processor, such as a general purpose microprocessor and/or an Application Specific Integrated Circuit (ASIC) that embodies all or part of the techniques according to implementations of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to implementations of the disclosed subject matter.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described in order to explain the principles of implementations of the disclosed subject matter and their practical applications, to thereby enable others skilled in the art to utilize those implementations as well as various implementations with various modifications as may be suited to the particular use contemplated.

1. A method comprising:
receiving, at a server, a utility bill and interval data for a user of an energy utility, and storing the received utility bill and interval data in a database system communicatively coupled to the server, wherein the received utility bill includes a date range for the bill and a tariff, and wherein the received interval data includes data used by the energy utility for determining costs;
determining, at a calculation engine of the server, a model bill based on the received utility bill and the interval data;
determining, at the server, an accuracy of a utility bill issued by the energy utility to by determining whether the model bill matches the utility bill; and
verifying, at the server, the utility bill, the interval data, and the tariff as accurate when the model bill matches the utility bill based on the accuracy determination.

2. The method of claim 1, wherein the receiving the utility bill and the interval data comprises:
receiving, at the server, login credential information of the user for the energy utility;
periodically accessing, at the server, at least one information selected from the group consisting of: the utility bill, date range for the utility bill, energy usage, historical billing information, the interval data, smart meter data, tariff information, past due amounts, and energy costs from the energy utility using the received login credential information of the user for the energy utility; and
storing, in the database system communicatively coupled to the server, the periodically accessed information.

3. The method of claim 1, wherein the determining the model bill further comprises:
determining, at a calculation engine of the server, the model bill based on a tariff model of the server, tariff data received from the database system based on the tariff, a start date of the date range, an end date of the date range, available smart meter data of the user, and an energy usage by the user.

4. The method of claim 3, further comprising:
applying, at the server using the tariff model, one or more rules based on at least one selected from the group consisting of: tariff rate amounts, geographic territory, season, time of use, demand determination, optional programs, net metering policy, and eligibility requirements for each tariff.

5. The method of claim 3, further comprising:
providing, at the calculation engine of the server, an application program interface (API) to calculate costs across a plurality of different energy utilities.

6. The method of claim 1, further comprising:
transmitting, at the server via a communications interface, a notification when the model bill does not match the utility bill based on the accuracy determination.

7. The method of claim 6, wherein when the model bill does not match the utility bill based on the accuracy determination, the method further comprising:
comparing, at the server, a total energy usage between the model bill and the utility bill;
when the total energy usage of the model bill does not match the corresponding energy usage of the utility bill, performing one or more operations at the server to determine whether the interval data is incomplete or misaligned.

8. The method of claim 7, wherein when there is no difference in the total energy usage between the model bill and the utility bill, the method further comprising:
comparing, at the server, energy costs of the model bill and the corresponding energy costs of the utility bill; and
when the energy costs of the utility bill do not match the corresponding energy costs of the model bill, performing one or more operations at the server to determine whether the tariff has been updated.

9. The method of claim 8, wherein at least one of the one or more operations at the server to determine whether the tariff has been updated comprises:
determining, at the server, whether the tariff has been updated in a tariff database of the database system that is communicatively coupled to the server.

10. The method of claim 8, wherein when there is no difference in the energy costs between the model bill and the utility bill, the method further comprising:
comparing, at the server, each discrete cost detailed in the utility bill with the corresponding costs detailed in the model bill; and
when one or more of the discrete costs detailed in the utility bill do not match with the corresponding costs detailed in the model bill, performing one or more operations at the server to determine a cost discrepancy.

11. The method of claim 10, wherein when the one or more operations do not determine the cost discrepancy, the method further comprising:
determining, at the server, whether there is an error in a billing operation by the energy utility.

12. The method of claim 11, wherein the determining comprises:
determining, at the server, whether there is a rate update by the energy utility;
determining, at the server, whether the cost discrepancy is based on the determined rate update;
transmitting, at the server, a notification when the cost discrepancy is based on the determined rate update; and
storing, in the database system communicatively coupled to the server, the determined rate update.

13. The method of claim 11, wherein the determining comprises:
determining, at the server, whether there is an update to the energy utility billing process;
determining, at the server, whether the cost discrepancy is based on the determined update to the energy utility billing process;
transmitting, at the server, a notification when the cost discrepancy is based on the determined update to the energy utility billing process; and
storing, in the database system communicatively coupled to the server, the determined update to the energy utility billing process.
